(19) United States
(12) Patent Application Publication
(10) Pub. No.: US 2023/0093641 A1
(43) Pub. Date: Mar. 23, 2023

(54) CERAMIC COMPOSITION AND WIRE-WOUND COIL COMPONENT

(71) Applicant: Murata Manufacturing Co., Ltd., Kyoto-fu (JP)

(72) Inventors: Atsushi SHIMAMURA, Nagaokakyo-shi (JP); Yuuki Kitadai, Nagaokakyo-shi (JP); Takanori Suzuki, Nagaokakyo-shi (JP)

(73) Assignee: Murata Manufacturing Co., Ltd., Kyoto-fu (JP)

(21) Appl. No.: 17/823,761

(22) Filed: Aug. 31, 2022

(30) Foreign Application Priority Data
Sep. 14, 2021 (JP) 2021-149659

(51) Int. Cl. C04B 35/26; H01F 1/34; H01F 17/04

(52) U.S. Cl. CPC C04B 35/265; H01F 1/344; H01F 17/045; C04B 2235/3281; C04B 2235/3284; C04B 2235/3279

(57) ABSTRACT

A ceramic composition contains Fe, Cu, Ni, Zn, Co, and Cr. When Fe, Cu, Ni, and Zn are converted to Fe₂O₃, CuO, NiO, and ZnO, respectively, and when a total amount of Fe₂O₃, CuO, NiO, and ZnO is 100 parts by mole, the ceramic composition contains 45.00 to 49.70 parts by mole Fe in terms of Fe₂O₃, 2.00 to 8.00 parts by mole Cu in terms of CuO, 19.40 to 45.40 parts by mole Ni in terms of NiO, and 1.00 to 27.00 parts by mole Zn in terms of ZnO. When Fe, Cu, Ni, and Zn are converted to Fe₂O₃, CuO, NiO, and ZnO, respectively, and when a total amount of Fe₂O₃, CuO, NiO, and ZnO is 100 parts by weight, the ceramic composition contains 5 to 100 ppm Co in terms of CoO and 10 to 400 ppm Cr in terms of Cr₂O₃.

### CROSS-REFERENCE TO RELATED APPLICATION

This application claims benefit of priority to Japanese Patent Application No. 2021-149659, filed Sep. 14, 2021, the entire content of which is incorporated herein by reference.

### BACKGROUND

### Technical Field

The present disclosure relates to a ceramic composition and a wire-wound coil component.

### Background Art

Japanese Unexamined Patent Application Publication No. 2018-125397 discloses a wire-wound coil device including a drum core having a winding core portion and flange portions. According to the coil device disclosed in Japanese Unexamined Patent Application Publication No. 2018-125397, a first protruding mounting portion on a flange portion located at an end of a winding core portion and a second protruding mounting portion on a flange portion located at the other end of the winding core portion are arranged in staggered positions; thus, the device has excellent thermal shock resistance.

### SUMMARY

Japanese Unexamined Patent Application Publication No. 2018-125397 discloses that the drum core is produced by forming and sintering a ferrite material, such as a Ni—Zn-based ferrite or a Mn—Zn-based ferrite. However, when the ferrite material used for the drum core does not have sufficient ceramic body strength (for example, flexural strength and toughness), the coil device mounted on, for example, a substrate may have reduced strength. Moreover, when the ferrite material used for the drum core does not have sufficient flexural strength or toughness, the drum core may be prone to chipping during a production process of the coil device.

A cross-point frequency, at which the reactance X is equal to the resistance R, is also desired to be high from the viewpoint of efficiently removing high-frequency noise components.

Accordingly, the present disclosure provides a ceramic composition having sufficient magnetic permeability, flexural strength, toughness, and a high cross-point frequency. The present disclosure also provides a wire-wound coil component including a sintered body of the above ceramic composition as a ceramic core.

A ceramic composition of the present disclosure contains Fe, Cu, Ni, Zn, Co, and Cr. When Fe, Cu, Ni, and Zn are converted to Fe₂O₃, CuO, NiO, and ZnO, respectively, and when the total amount of the Fe₂O₃, the CuO, the NiO, and the ZnO is 100 parts by mole, the ceramic composition contains 45.00 parts or more by mole and 49.70 parts or less by mole (i.e., from 45.00 parts by mole to 49.70 parts by mole) Fe in terms of Fe₂O₃, 2.00 parts or more by mole and 8.00 parts or less by mole (i.e., from 2.00 parts by mole to 8.00 parts by mole) Cu in terms of CuO, 19.40 parts or more by mole and 45.40 parts or less by mole (i.e., from 19.40 parts by mole to 45.40 parts by mole) Ni in terms of NiO, and 1.00 part or more by mole and 27.00 parts or less by mole (i.e., from 1.00 part by mole to 27.00 parts by mole) Zn in terms of ZnO. and in which when Fe, Cu, Ni, and Zn are converted to Fe₂O₃, CuO, NiO, and ZnO, respectively, and when the total amount of the Fe₂O₃, the CuO, the NiO, and the ZnO is 100 parts by weight, the ceramic composition contains 5 ppm or more and 100 ppm or less (i.e., from 5 ppm to 100 ppm) Co in terms of CoO and 10 ppm or more and 400 ppm or less (i.e., from 10 ppm to 400 ppm) Cr in terms of Cr₂O₃.

A wire-wound coil component of the present disclosure includes a ceramic core including a sintered body of the ceramic composition of the present disclosure, an axial core portion, and a pair of flange portions disposed at both end portions of the axial core portion opposite each other in a longitudinal direction of the axial core portion, an electrode disposed on an end surface of each of the flange portions in the height direction, and a winding disposed around the axial core portion, the winding having an end portion electrically coupled to the electrode.

According to the present disclosure, it is possible to provide the ceramic composition having sufficient magnetic permeability, flexural strength, toughness, and a high cross-point frequency.

### BRIEF DESCRIPTION OF THE DRAWINGS

FIG. 1 is a front view schematically illustrating an example of a wire-wound coil component of the present disclosure; and

FIG. 2 is a perspective view schematically illustrating an example of a ceramic core included in the wire-wound coil component illustrated in FIG. 1.

### DETAILED DESCRIPTION

A ceramic composition and a wire-wound coil component according to the present disclosure will be described below.

The present disclosure is not limited to configurations described below, but can be modified as appropriate without departing from the scope of the present disclosure. The present disclosure also includes a combination of two or more individual preferable configurations according to the present disclosure described below.

Ceramic Composition

A ceramic composition of the present disclosure contains Fe, Cu, Ni, Zn, Co, and Cr. The ceramic composition of the present disclosure contains, for example, ferrite, preferably spinel-type ferrite, as a main component.

When Fe, Cu, Ni, and Zn are converted to Fe₂O₃, CuO, NiO, and ZnO, respectively, and when the total amount of the Fe₂O₃, the CuO, the NiO, and the ZnO is 100 parts by mole, the ceramic composition of the present disclosure contains 45.00 parts or more by mole and 49.70 parts or less by mole (i.e., from 45.00 parts by mole to 49.70 parts by mole) Fe in terms of Fe₂O₃, 2.00 parts or more by mole and 8.00 parts or less by mole (i.e., from 2.00 parts by mole to 8.00 parts by mole) Cu in terms of CuO, 19.40 parts or more by mole and 45.40 parts or less by mole (i.e., from 19.40 parts by mole to 45.40 parts by mole) Ni in terms of NiO, and 1.00 part or more by mole and 27.00 parts or less by mole (i.e., from 1.00 part by mole to 27.00 parts by mole) Zn in terms of ZnO.

When Fe, Cu, Ni, and Zn are converted to Fe₂O₃, CuO, NiO, and ZnO, respectively, and when the total amount of the Fe₂O₃, the CuO, the NiO, and the ZnO is 100 parts by weight, the ceramic composition of the present disclosure contains 5 ppm or more and 100 ppm or less (i.e., from 5 ppm to 100 ppm) Co in terms of CoO and 10 ppm or more and 400 ppm or less (i.e., from 10 ppm to 400 ppm) Cr in terms of Cr₂O₃.

In the ceramic composition of the present disclosure, the magnetic permeability, the flexural strength, the toughness, and the cross-point frequency can be increased by setting the Fe, Cu, Ni, Zn, Co, and Cr contents within the above ranges. For example, it is possible to provide a ceramic composition having a magnetic permeability p, of 30 or more, a cross-point frequency of 8 MHz or more, a flexural strength of 170.0 MPa or more, and a toughness value Kc of 1.00 Pa·m^{1/2} or more.

The amount of each element contained can be determined by analyzing the composition of a sintered body of the ceramic composition using inductively coupled plasma atomic emission spectrometry/mass spectrometry (ICP-AES/MS).

When the total amount of the Fe₂O₃, the CuO, the NiO, and the ZnO is 100 parts by weight, preferably, the ceramic composition of the present disclosure further contains 500 ppm or more and 3,800 ppm or less (i.e., from 500 ppm to 3,800 ppm) Mn in terms of Mn₂O₃. When the ceramic composition contains Mn within the above range, the cross-point frequency can be further increased. The ceramic composition of the present disclosure need not contain Mn.

When the total amount of the Fe₂O₃, the CuO, the NiO, and the ZnO is 100 parts by weight, preferably, the ceramic composition of the present disclosure further contains 5 ppm or more and 50 ppm or less (i.e., from 5 ppm to 50 ppm) Mg in terms of MgO. When the ceramic composition contains Mg within the above range, the cross-point frequency can be further increased. The ceramic composition of the present disclosure need not contain Mg.

When the total amount of the Fe₂O₃, the CuO, the NiO, and the ZnO is 100 parts by weight, preferably, the ceramic composition of the present disclosure further contains 0.6 ppm or more and 30 ppm or less (i.e., from 0.6 ppm to 30 ppm) Ba in terms of BaO. When the ceramic composition contains Ba within the above range, both the flexural strength and toughness can be increased, compared to ceramic compositions containing no Ba. The ceramic composition of the present disclosure need not contain Ba.

When the total amount of the Fe₂O₃, the CuO, the NiO, and the ZnO is 100 parts by weight, preferably, the ceramic composition of the present disclosure further contains 0.6 ppm or more and 80 ppm or less (i.e., from 0.6 ppm to 80 ppm) Ge in terms of GeO₂. When the ceramic composition contains Ge within the above range, the flexural strength and the toughness can further be increased. The ceramic composition of the present disclosure need not contain Ge.

The ceramic composition of the present disclosure is preferably manufactured as described below.

Fe₂O₃, CuO, NiO, ZnO, CoO, and Cr₂O₃ are weighed in such a manner that the resulting composition after firing is a predetermined composition. These raw materials to be mixed are placed in a ball mill along with deionized water and partially stabilized zirconia (PSZ) balls, mixed, and pulverized by a wet process for a predetermined time (for example, 4 hours or more and 8 hours or less (i.e., from 4 hours to 8 hours)). The resulting mixture is dried by evaporation and then calcined at a predetermined temperature (for example, 700° C. or higher and 800° C. or lower (i.e., from 700° C. to 800° C.)) for a predetermined time (for example, 2 hours or more and 5 hours or less (i.e., from 2 hours to 5 hours)) to form a calcined material (calcined powder).

The resulting calcined material (calcined powder) is placed in a ball mill together with deionized water, poly(vinyl alcohol) serving as a binder, a dispersant, a plasticizer, and PSZ balls, mixed, and pulverized by a wet process. The resulting slurry is dried and granulated with a spray dryer to prepare a granulated powder.

Metal dies are provided. The resulting granulated powder is compacted by pressing to form a green compact.

The resulting green compact is fired by holding the green compact in a firing furnace at a predetermined temperature (for example, 1,100° C. or higher and 1,200° C. or lower (i.e., from 1,100° C. to 1,200° C.)) for a predetermined time (for example, 2 hours or more and 5 hours or less (i.e., from 2 hours to 5 hours)). The ceramic composition is manufactured by the above manufacturing process.

Examples in which a ceramic composition of the present disclosure is more specifically disclosed will be described below. The present disclosure is not limited only to these examples.

### Example 1

Fe₂O₃, CuO, NiO, ZnO, CoO, and Cr₂O₃ were weighed in such a manner that the composition after firing was a composition given in Table 1. These raw materials to be mixed were placed in a ball mill along with deionized water and PSZ balls, mixed, and pulverized by a wet process for 4 hours. The resulting mixture was dried by evaporation and then calcined at 800° C. for 2 hours to form a calcined material. In addition to the above raw materials, Mn₂O₃, MgO, BaO, and GeO₂ were also placed in the above ball mill as raw materials to be mixed.

The resulting calcined material was placed in a ball mill along with deionized water, poly(vinyl alcohol) serving as a binder, a dispersant, a plasticizer, and PSZ balls, mixed, and pulverized. The resulting slurry was dried and granulated with a spray dryer to prepare a granulated powder.

The resulting granulated powder was compacted by pressing to form green compacts that will be fired to form the following specimens:

ring-shaped specimens having an outside diameter of 20 mm, an inside diameter of 12 mm, and a thickness of 1.5 mm, and

single-plate specimens having dimensions of 4 mm×2 mm×1.5 mm.

The resulting green compacts were fired at 1,100° C. for 2 hours. Thereby, samples 1 to 21 were manufactured.

Regarding the single-plate specimens of each of the samples, the amounts of the elements contained were measured by analyzing the compositions of the sintered bodies using ICP-AES/MS. Table 1 presents the results. In Table 1, the values of Fe, Cu, Ni, Zn, Co, and Cr are expressed in terms of oxides.

Each of the ring-shaped specimens was placed in a magnetic permeability measurement fixture (16454A-s, available from Agilent Technologies, Inc). The initial permeability was measured as the magnetic permeability μ with an impedance analyzer (E4991A, available from Agilent Technologies, Inc.) at 25±2° C. and a measurement frequency of 1 MHz. The frequency characteristics of the reactance X and the resistance R were measured to determine the cross-point frequency at which X is equal to R. Table 1 presents the results.

The flexural strength of each of the single-plate specimens was measured by a three-point flexural test. The specimens after firing were used for the measurement of the flexural strength. The flexural strength was determined by measuring 10 specimens and averaging the resulting values. Table 1 presents the results.

The toughness value Kc was measured by the Vickers test for each single-plate specimen.

Each specimen after firing was fixed with a resin. The cross section to be used as a measurement surface was polished, and then the toughness value Kc was measured. The toughness value Kc was determined by measuring 10 specimens and averaging the resulting values. Table 1 presents the results.

The details of a method for measuring the toughness value Kc are described below.

A cross section was subjected to rough polishing with Tegramin-25 (available from Struers) and then buffing with 3 μm and 1 μm diamond abrasive grains, thereby exposing the cross section for forming the indentation as the measurement surface.

Indentations and cracks were formed using a Micro Vickers Hardness Tester (HM220, available from Mitutoyo Corporation) at a load of 1.0 N, a load time of 1 s, a holding time of 4 s, and an approach speed of 60 μm/1 s.

The toughness value Kc was calculated by the following equation according to JIS R 1607.

Kc=0.018×(E/HV)^{1/2}×(P/C^{3/2})=0.026×E^{1/2}×P^{1/2}×a/C^{3/2}

Kc: Fracture toughness value [Pa·m^{1/2}]

E: Elastic modulus [Pa]*a value measured according to JIS R 1602 is used.

HV: Vickers hardness [Pa]

P: Indentation load [N]

C: Half of average crack length [m]

a: half of average length of diagonal line of indentation [m].

TABLE 1

| | Fe₂O₃ | CuO | NiO | ZnO | | | | | | |
|---|---|---|---|---|---|---|---|---|---|---|
| | (parts | (parts | (parts | (parts | | | Magnetic | Cross-point | Flexural | Toughness |
| Sample | by | by | by | by | CoO | Cr₂O₃ | permeability | frequency | strength | value Kc |
| No. | mole) | mole) | mole) | mole) | (ppm) | (ppm) | μ (—) | (MHz) | (MPa) | (Pa · m^{1/2}) |
| *1 | 48.00 | 0.50 | 31.50 | 20.00 | 50 | 250 | 157 | 37 | 166.4 | 1.33 |
| 2 | 48.00 | 2.00 | 30.00 | 20.00 | 50 | 250 | 174 | 35 | 214.0 | 1.28 |
| 3 | 48.00 | 5.60 | 26.40 | 20.00 | 50 | 250 | 225 | 25 | 230.3 | 1.24 |
| 4 | 48.00 | 8.00 | 24.00 | 20.00 | 50 | 250 | 279 | 20 | 224.5 | 1.15 |
| *5 | 48.00 | 8.30 | 23.70 | 20.00 | 50 | 250 | 286 | 20 | 205.0 | 0.97 |
| *6 | 48.00 | 5.60 | 46.10 | 0.30 | 50 | 250 | 24 | 260 | 190.7 | 1.11 |
| 7 | 48.00 | 5.60 | 45.40 | 1.00 | 50 | 250 | 30 | 228 | 205.9 | 1.14 |
| 8 | 48.00 | 5.60 | 19.40 | 27.00 | 50 | 250 | 677 | 8 | 224.9 | 1.25 |
| *9 | 48.00 | 5.60 | 15.40 | 31.00 | 50 | 250 | 1121 | 5 | 222.7 | 1.17 |
| *10 | 44.50 | 5.60 | 29.90 | 20.00 | 50 | 250 | 164 | 35 | 168.2 | 1.30 |
| 11 | 45.00 | 5.60 | 29.40 | 20.00 | 50 | 250 | 167 | 34 | 190.1 | 1.26 |
| 12 | 49.70 | 5.60 | 24.70 | 20.00 | 50 | 250 | 262 | 22 | 223.2 | 1.09 |
| *13 | 50.20 | 5.60 | 24.20 | 20.00 | 50 | 250 | 244 | 24 | 219.1 | 0.97 |
| *14 | 48.00 | 5.60 | 26.40 | 20.00 | 2 | 250 | 265 | 20 | 205.3 | 0.98 |
| 15 | 48.00 | 5.60 | 26.40 | 20.00 | 5 | 250 | 254 | 22 | 210.3 | 1.01 |
| 16 | 48.00 | 5.60 | 26.40 | 20.00 | 100 | 250 | 198 | 30 | 185.3 | 1.24 |
| *17 | 48.00 | 5.60 | 26.40 | 20.00 | 200 | 250 | 164 | 37 | 167.3 | 1.29 |
| *18 | 48.00 | 5.60 | 26.40 | 20.00 | 50 | 3 | 198 | 31 | 169.5 | 1.24 |
| 19 | 48.00 | 5.60 | 26.40 | 20.00 | 50 | 10 | 214 | 28 | 181.3 | 1.19 |
| 20 | 48.00 | 5.60 | 26.40 | 20.00 | 50 | 400 | 243 | 24 | 199.3 | 1.03 |
| *21 | 48.00 | 5.60 | 26.40 | 20.00 | 50 | 570 | 254 | 23 | 205.3 | 0.97 |

In Table 1, the samples marked with * are comparative examples outside the scope of the present disclosure.

As presented in Table 1, in samples 2 to 4, 7, 8, 11, 12, 15, 16, 19, and 20, in which when Fe, Cu, Ni, and Zn are converted to Fe₂O₃, CuO, NiO, and ZnO, respectively, and when the total amount of the Fe₂O₃, the CuO, the NiO, and the ZnO is 100 parts by mole, each of the samples contains 45.00 parts or more by mole and 49.70 parts or less by mole (i.e., from 45.00 parts by mole to 49.70 parts by mole) Fe in terms of Fe₂O₃, 2.00 parts or more by mole and 8.00 parts or less by mole (i.e., from parts by mole to 8.00 parts by mole) Cu in terms of CuO, 19.40 parts or more by mole and 45.40 parts or less by mole (i.e., from 19.40 parts by mole to 45.40 parts by mole) Ni in terms of NiO, and 1.00 part or more by mole and 27.00 parts or less by mole (i.e., from 1.00 part by mole to 27.00 parts by mole) Zn in terms of ZnO, and in which when Fe, Cu, Ni, and Zn are converted to Fe₂O₃, CuO, NiO, and ZnO, respectively, and when the total amount of the Fe₂O₃, the CuO, the NiO, and the ZnO is 100 parts by weight, each of the samples contains 5 ppm or more and 100 ppm or less (i.e., from 5 ppm to 100 ppm) Co in terms of CoO and 10 ppm or more and 400 ppm or less (i.e., from 10 ppm to 400 ppm) Cr in terms of Cr₂O₃, ceramic compositions having a magnetic permeability p, of 30 or more, a cross-point frequency of 8 MHz or more, a flexural strength of 170.0 MPa or more, and a toughness value Kc of 1.00 Pa·m^{1/2} or more are provided.

### Example 2

Sample 3 in Table 1 contains 2,500 ppm Mn in terms of Mn₂O₃ in its composition after firing. Samples 22 to 25 having the same composition as sample 3 in Table 1 were manufactured, except that each of samples 22 to 25 contained 100 ppm, 500 ppm, 3,800 ppm, or 4,500 ppm Mn in terms of Mn₂O₃ in the composition after firing. The same evaluation as in Example 1 was performed. A method for measuring the Mn content was the same as in Example 1. Table 2 presents the results.

TABLE 2

| | | Magnetic | Cross-point | Flexural | Toughness |
|---|---|---|---|---|---|
| Sample | Mn₂O₃ | permeability | frequency | strength | value Kc |
| No. | (ppm) | μ (—) | (MHz) | (MPa) | (Pa · m^{1/2}) |
| 22 | 100 | 157 | 22 | 205.3 | 1.01 |
| 23 | 500 | 220 | 27 | 191.3 | 1.03 |
| 3 | 2500 | 225 | 25 | 230.3 | 1.24 |
| 24 | 3800 | 243 | 26 | 215.3 | 1.06 |
| 25 | 4500 | 193 | 20 | 211.3 | 1.00 |

As presented in Table 2, each of samples 23, 3, and 24 containing 500 ppm or more and 3,800 ppm or less (i.e., from 500 ppm to 3,800 ppm) Mn in terms of Mn₂O₃ had an increased cross-point frequency, compared with samples 22 and 25.

### Example 3

Sample 3 in Table 1 contains 20 ppm Mg in terms of MgO in its composition after firing. Samples 26 to 29 having the same composition as sample 3 in Table 1 were manufactured, except that each of samples 26 to 29 contained 2 ppm, 5 ppm, 50 ppm, or 80 ppm Mg in terms of MgO in the composition after firing. The same evaluation as in Example 1 was performed. A method for measuring the Mg content was the same as in Example 1. Table 3 presents the results.

TABLE 3

| | | Magnetic | Cross-point | Flexural | Toughness |
|---|---|---|---|---|---|
| Sample | MgO | permeability | frequency | strength | value Kc |
| No. | (ppm) | μ (—) | (MHz) | (MPa) | (Pa · m^{1/2}) |
| 26 | 2 | 245 | 18 | 170.8 | 1.28 |
| 27 | 5 | 234 | 24 | 185.3 | 1.21 |
| 3 | 20 | 225 | 25 | 230.3 | 1.24 |
| 28 | 50 | 247 | 24 | 220.3 | 1.15 |
| 29 | 80 | 261 | 15 | 195.3 | 1.02 |

As presented in Table 3, each of samples 27, 3, and 28 containing 5 ppm or more and 50 ppm or less (i.e., from 5 ppm to 50 ppm) Mg in terms of MgO had an increased cross-point frequency, compared with samples 26 and 29.

### Example 4

Sample 3 in Table 1 contains 5 ppm Ba in terms of BaO in its composition after firing. Samples 30 to 33 having the same composition as sample 3 in Table 1 were manufactured, except that each of samples 30 to 33 contained 0 ppm, 0.6 ppm, 30 ppm, or 50 ppm Ba in terms of BaO in the composition after firing. The same evaluation as in Example 1 was performed. A method for measuring the Ba content was the same as in Example 1. Table 4 presents the results.

TABLE 4

| | | Magnetic | Cross-point | Flexural | Toughness |
|---|---|---|---|---|---|
| Sample | BaO | permeability | frequency | strength | value Kc |
| No. | (ppm) | μ (—) | (MHz) | (MPa) | (Pa · m^{1/2}) |
| 30 | 0 | 240 | 24 | 195.3 | 1.01 |
| 31 | 0.6 | 232 | 24 | 211.3 | 1.21 |
| 3 | 5 | 225 | 25 | 230.3 | 1.24 |
| 32 | 30 | 216 | 28 | 219.3 | 1.33 |
| 33 | 50 | 209 | 29 | 170.2 | 1.24 |

As presented in Table 4, in each of samples 31, 3, and 32 containing 0.6 ppm or more and 30 ppm or less (i.e., from 0.6 ppm to 30 ppm) Ba in terms of BaO, both of the flexural strength and the toughness value Kc are increased as compared with sample 30, unlike sample 33.

### Example 5

Sample 3 in Table 1 contains 20 ppm Ge in terms of GeO₂ in its composition after firing. Samples 34 to 37 having the same composition as sample 3 in Table 1 were manufactured, except that each of samples 34 to 37 contained 0 ppm, 0.6 ppm, 80 ppm, or 130 ppm Ge in terms of GeO₂ in the composition after firing. The same evaluation as in Example 1 was performed. A method for measuring the Ge content was the same as in Example 1. Table 5 presents the results.

TABLE 5

| | | Magnetic | Cross-point | Flexural | Toughness |
|---|---|---|---|---|---|
| Sample | GeO₂ | permeability | frequency | strength | value Kc |
| No. | (ppm) | μ (—) | (MHz) | (MPa) | (Pa · m^{1/2}) |
| 34 | 0 | 211 | 27 | 215.3 | 1.03 |
| 35 | 0.6 | 216 | 26 | 228.3 | 1.24 |
| 3 | 20 | 225 | 25 | 230.3 | 1.24 |
| 36 | 80 | 234 | 25 | 235.3 | 1.22 |
| 37 | 130 | 184 | 35 | 174.1 | 1.08 |

As presented in Table 5, in each of samples 35, 3, and 36 containing 0.6 ppm or more and 80 ppm or less (i.e., from 0.6 ppm to 80 ppm) Ge in terms of GeO₂, both of the flexural strength and the toughness value Kc are increased as compared with samples 34 and 37.

Although not given in Table 1 of Example 1, samples 1, 2, and 4 to 21 each contain Mn₂O₃, MgO, BaO, and GeO₂ in a composition similar to that of sample 3.

### Wire-Wound Coil Component

A wire-wound coil component of the present disclosure includes a sintered body of a ceramic composition of the present disclosure as a ceramic core. As described above, the ceramic composition of the present disclosure has sufficient magnetic permeability, flexural strength, and toughness, and thus can be suitably used as a wire-wound coil component used in an environment where shock resistance is required, such as in an automotive application. Moreover, the ceramic composition of the present disclosure has a high cross-point frequency and thus can be suitably used as a wire-wound coil component for efficiently removing a high-frequency noise component.

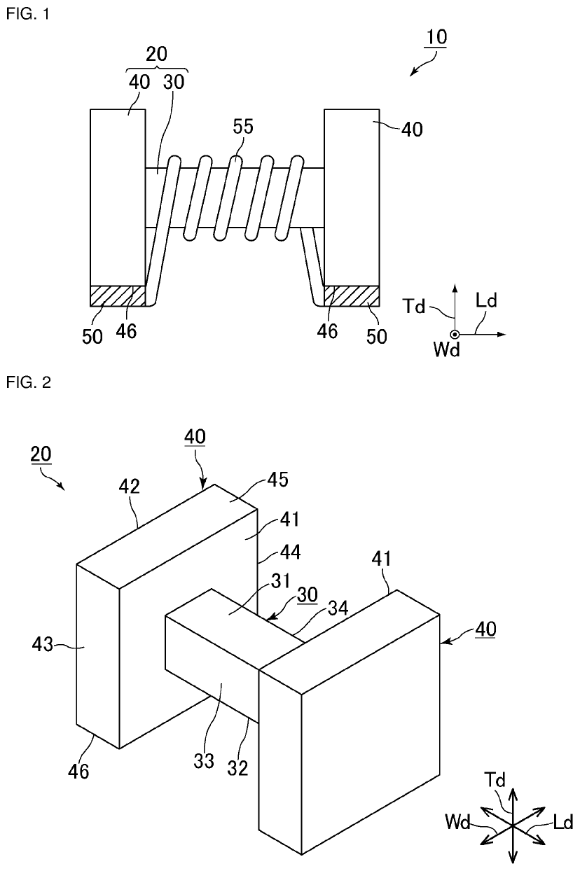

FIG. 1 is a front view schematically illustrating an example of a wire-wound coil component of the present disclosure. FIG. 2 is a perspective view schematically illustrating an example of a ceramic core included in the wire-wound coil component illustrated in FIG. 1.

FIGS. 1 and 2 are schematic, and the dimensions and the scale of the aspect ratio may be different from those of the actual products.

A wire-wound coil component 10 illustrated in FIG. 1 includes a ceramic core 20, electrodes 50, and a winding (coil) 55. The ceramic core 20 is formed of a sintered body of a ceramic composition of the present disclosure.

As illustrated in FIG. 2, the ceramic core 20 includes an axial core portion 30 and a pair of flange portions 40 disposed at both end portions of the axial core portion 30 opposite each other in the longitudinal direction of the axial core portion 30. The axial core portion 30 and the flange portions 40 are formed in one piece.

In this specification, as illustrated in FIGS. 1 and 2, the direction in which the pair of the flange portions 40 are arranged side by side is defined as a longitudinal direction Ld. Of the directions perpendicular to the longitudinal direction Ld, the vertical direction in FIGS. 1 and 2 is defined as a height direction (thickness direction) Td, and the direction perpendicular to both the longitudinal direction Ld and the height direction Td is defined as a width direction Wd.

The axial core portion 30 has, for example, a rectangular parallelepiped shape extending in the longitudinal direction Ld. The central axis of the axial core portion 30 extends substantially parallel to the longitudinal direction Ld. The axial core portion 30 has a pair of main surfaces 31 and 32 opposite each other in the height direction Td and a pair of side surfaces 33 and 34 opposite each other in the width direction Wd.

In this specification, the term “rectangular parallelepiped shape” includes a rectangular parallelepiped with chamfered corners and edges, and a rectangular parallelepiped with rounded corners and edges. Irregularities may be present in the whole or part of each of the main surfaces and the side surfaces.

The pair of the flange portions 40 is provided at both end portions of the axial core portion 30 in the longitudinal direction Ld. Each of the flange portions 40 has a rectangular parallelepiped shape with a relatively small dimension in the longitudinal direction Ld. Each flange portion 40 extends around the axial core portion 30 in the height direction Td and the width direction Wd. Specifically, when viewed in the longitudinal direction Ld, each flange portion 40 has a planar shape extending from the axial core portion 30 in the height direction Td and the width direction Wd.

Each of the flange portions 40 has a pair of main surfaces 41 and 42 opposite each other in the longitudinal direction Ld, a pair of side surfaces 43 and 44 opposite each other in the width direction Wd, and a pair of end surfaces 45 and 46 opposite each other in the height direction Td. The main surface 41 of one of the flange portions 40 faces the main surface 41 of the other flange portion 40.

For example, the entire main surface 41 of each of the flange portions 40 extends substantially perpendicular to the direction in which the central axis of the axial core portion 30 extends (that is, the longitudinal direction Ld). In other words, the entire main surface 41 of each flange portion 40 extends substantially parallel to the height direction Td. However, the main surface 41 of each flange portion 40 may have an inclination.

As illustrated in FIG. 1, the electrodes 50 are disposed on the end surfaces 46 of the respective flange portions 40 in the height direction Td. For example, the electrodes 50 are electrically coupled to electrodes of a circuit board when the wire-wound coil component 10 is mounted on the circuit board. The electrodes 50 are composed of, for example, a nickel-based alloy, such as nickel (Ni)-chromium (Cr) or Ni-copper (Cu), silver (Ag), Cu, or tin (Sn).

The winding 55 is disposed around the axial core portion 30. The winding 55 has a structure in which a core wire mainly composed of a conductive material, such as Cu, is covered with an insulating material, such as polyurethane, polyimide, or imide-modified polyurethane. Both end portions of the winding 55 are electrically coupled to the respective electrodes 50.

For example, the wire-wound coil component of the present disclosure is manufactured as described below.

As described in “Ceramic Composition” above, a granulated powder is compacted by pressing to form a green compact. The green compact is fired by holding the green compact in a firing furnace at a predetermined temperature (for example, 1,100° C. or higher and 1,200° C. or less (i.e., from 1,100° C. to 1,200° C.)) for a predetermined time (for example, 2 hours or more and 5 hours or less (i.e., from 2 hours to 5 hours)). The resulting sintered body is placed in a barrel and polished with an abrasive. This barrel polishing removes burrs from the sintered body, resulting in curved roundness on the outer surface of the sintered body (especially the corners and ridges). The above manufacturing process results in a ceramic core as illustrated in FIG. 2.

Subsequently, an electrode is formed on an end surface of each of the flange portions of the ceramic core. For example, a conductive paste containing, for example, Ag and glass frit is applied to the end surface of each flange portion and subjected to baking treatment at a predetermined temperature (for example, 800° C. or higher and 820° C. or lower (i.e., from 800° C. to 820° C.)) to form an underlying metal layer. Then a Ni plating film and a Sn plating film are sequentially formed on the underlying metal layer by electrolytic plating to form the electrode. As another method for forming the electrodes, metal terminals may be used as the electrodes by attaching the metal terminals to the end surfaces of the flange portions.

A winding is formed around the axial core portion of the ceramic core. Then end portions of the winding are joined to the electrodes by a known method, such as thermocompression bonding. The wire-wound coil component as illustrated in FIG. 1 can be manufactured through the above process.

A wire-wound coil component of the present disclosure is not limited only to the foregoing embodiments, and various applications and changes can be made within the scope of the present disclosure. As another shape, for example, a top plate extending in the longitudinal direction Ld and connecting between the flange portions may be provided. The winding may be covered with a resin. The shape of the core is not limited to a drum core and may be an annular core.

In a wire-wound coil component of the present disclosure, the shape and size of the axial core portion of the ceramic core, the shape and size of the flange portions of the ceramic core, the thickness of the winding (wire diameter), the number of turns, the cross-sectional shape of the winding, and the number of windings are not particularly limited and can be appropriately changed in accordance with the desired characteristics and mounting location. The positions and number of electrodes can also be appropriately set in accordance with the number of windings and the application.

What is claimed is:

1. A ceramic composition, comprising Fe, Cu, Ni, Zn, Co, and Cr,
wherein when Fe, Cu, Ni, and Zn are converted to Fe₂O₃, CuO, NiO, and ZnO, respectively, and when a total amount of the Fe₂O₃, the CuO, the NiO, and the ZnO is 100 parts by mole, the ceramic composition comprises:
from 45.00 parts by mole to 49.70 parts by mole Fe in terms of Fe₂O₃;
from 2.00 parts by mole to 8.00 parts by mole Cu in terms of CuO;
from 19.40 parts by mole to 45.40 parts by mole Ni in terms of NiO; and
from 1.00 part by mole to 27.00 parts by mole Zn in terms of ZnO, and
wherein when Fe, Cu, Ni, and Zn are converted to Fe₂O₃, CuO, NiO, and ZnO, respectively, and when a total amount of the Fe₂O₃, the CuO, the NiO, and the ZnO is 100 parts by weight, the ceramic composition comprises:
from 5 ppm to 100 ppm Co in terms of CoO; and
from 10 ppm to 400 ppm Cr in terms of Cr₂O₃.

2. The ceramic composition according to claim 1, wherein
when the total amount of the Fe₂O₃, the CuO, the NiO, and the ZnO is 100 parts by weight, the ceramic composition further comprises from 500 ppm to 3,800 ppm Mn in terms of Mn₂O₃.

3. The ceramic composition according to claim 1, wherein
when the total amount of the Fe₂O₃, the CuO, the NiO, and the ZnO is 100 parts by weight, the ceramic composition further comprises from 5 ppm to 50 ppm Mg in terms of MgO.

4. The ceramic composition according to claim 1, wherein
when the total amount of the Fe₂O₃, the CuO, the NiO, and the ZnO is 100 parts by weight, the ceramic composition further comprises from 0.6 ppm to 30 ppm Ba in terms of BaO.

5. The ceramic composition according to claim 1, wherein
when the total amount of the Fe₂O₃, the CuO, the NiO, and the ZnO is 100 parts by weight, the ceramic composition further comprises from 0.6 ppm to 80 ppm Ge in terms of GeO₂.

6. A wire-wound coil component, comprising:
a ceramic core including a sintered body of the ceramic composition according to claim 1, an axial core portion, and a pair of flange portions disposed at both end portions of the axial core portion opposite each other in a longitudinal direction of the axial core portion;
an electrode disposed on an end surface of each of the flange portions in a height direction; and
a winding disposed around the axial core portion, the winding having an end portion electrically coupled to the electrode.

7. The ceramic composition according to claim 2, wherein
when the total amount of the Fe₂O₃, the CuO, the NiO, and the ZnO is 100 parts by weight, the ceramic composition further comprises from 5 ppm to 50 ppm Mg in terms of MgO.

8. The ceramic composition according to claim 2, wherein
when the total amount of the Fe₂O₃, the CuO, the NiO, and the ZnO is 100 parts by weight, the ceramic composition further comprises from 0.6 ppm to 30 ppm Ba in terms of BaO.

9. The ceramic composition according to claim 3, wherein
when the total amount of the Fe₂O₃, the CuO, the NiO, and the ZnO is 100 parts by weight, the ceramic composition further comprises from 0.6 ppm to 30 ppm Ba in terms of BaO.

10. The ceramic composition according to claim 7, wherein
when the total amount of the Fe₂O₃, the CuO, the NiO, and the ZnO is 100 parts by weight, the ceramic composition further comprises from 0.6 ppm to 30 ppm Ba in terms of BaO.

11. The ceramic composition according to claim 2, wherein
when the total amount of the Fe₂O₃, the CuO, the NiO, and the ZnO is 100 parts by weight, the ceramic composition further comprises from 0.6 ppm to 80 ppm Ge in terms of GeO₂.

12. The ceramic composition according to claim 3, wherein
when the total amount of the Fe₂O₃, the CuO, the NiO, and the ZnO is 100 parts by weight, the ceramic composition further comprises from 0.6 ppm to 80 ppm Ge in terms of GeO₂.

13. The ceramic composition according to claim 4, wherein
when the total amount of the Fe₂O₃, the CuO, the NiO, and the ZnO is 100 parts by weight, the ceramic composition further comprises from 0.6 ppm to 80 ppm Ge in terms of GeO₂.

14. The ceramic composition according to claim 7, wherein
when the total amount of the Fe₂O₃, the CuO, the NiO, and the ZnO is 100 parts by weight, the ceramic composition further comprises from 0.6 ppm to 80 ppm Ge in terms of GeO₂.

15. The ceramic composition according to claim 8, wherein
when the total amount of the Fe₂O₃, the CuO, the NiO, and the ZnO is 100 parts by weight, the ceramic composition further comprises from 0.6 ppm to 80 ppm Ge in terms of GeO₂.

16. The ceramic composition according to claim 9, wherein
when the total amount of the Fe₂O₃, the CuO, the NiO, and the ZnO is 100 parts by weight, the ceramic composition further comprises from 0.6 ppm to 80 ppm Ge in terms of GeO₂.

17. A wire-wound coil component, comprising:
a ceramic core including a sintered body of the ceramic composition according to claim 2, an axial core portion, and a pair of flange portions disposed at both end portions of the axial core portion opposite each other in a longitudinal direction of the axial core portion;
an electrode disposed on an end surface of each of the flange portions in a height direction; and
a winding disposed around the axial core portion, the winding having an end portion electrically coupled to the electrode.

18. A wire-wound coil component, comprising:
a ceramic core including a sintered body of the ceramic composition according to claim 3, an axial core portion, and a pair of flange portions disposed at both end portions of the axial core portion opposite each other in a longitudinal direction of the axial core portion;
an electrode disposed on an end surface of each of the flange portions in a height direction; and
a winding disposed around the axial core portion, the winding having an end portion electrically coupled to the electrode.

19. A wire-wound coil component, comprising:
a ceramic core including a sintered body of the ceramic composition according to claim 4, an axial core portion, and a pair of flange portions disposed at both end portions of the axial core portion opposite each other in a longitudinal direction of the axial core portion;
an electrode disposed on an end surface of each of the flange portions in a height direction; and
a winding disposed around the axial core portion, the winding having an end portion electrically coupled to the electrode.

20. A wire-wound coil component, comprising:
a ceramic core including a sintered body of the ceramic composition according to claim 5, an axial core portion, and a pair of flange portions disposed at both end portions of the axial core portion opposite each other in a longitudinal direction of the axial core portion;
an electrode disposed on an end surface of each of the flange portions in a height direction; and
a winding disposed around the axial core portion, the winding having an end portion electrically coupled to the electrode.
